(19) United States
(12) Patent Application Publication
(10) Pub. No.: US 2011/0013964 A1
(43) Pub. Date: Jan. 20, 2011

(54) OPENING/CLOSING DOOR, APPARATUS HOUSING USING THE SAME AND IMAGE FORMING APPARATUS

(75) Inventors: Hiromichi ISHIYAMA, Kanagawa (JP); Shuya Yamamoto, Kanagawa (JP); Tetsuya Satozaki, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/829,983

(22) Filed: Jul. 2, 2010

(30) Foreign Application Priority Data
Jul. 20, 2009 (JP) 2009-169632

(51) Int. Cl. B41J 29/02; E06B 3/34; E05B 1/00; A47B 96/00

(52) U.S. Cl. 400/693; 49/400; 312/326

(57) ABSTRACT

An opening/closing door for opening/closing a door opening formed in an apparatus housing includes: a rotational shaft mounted at an edge portion of the door opening; a door base member that is fixed to the rotational shaft and rotates together with the rotational shaft; a door exterior member fixed to the exterior of the door base member; plural positioning units that position the door exterior member to the door base member at locations distant from the rotational shaft; plural fixing units that are provided to be more distant from the rotational shaft than the plural positioning units and fix the door exterior member to the door base member by attachments; and an opening/closing handle that is provided to the door exterior member so as to be closer to the fixing units than the positioning units in a direction substantially orthogonal to the rotational shaft.

### CROSS-REFERENCE TO RELATED APPLICATION

This application is based on and claims priority under 35 USC 119 from Japanese Patent Application No. 2009-169632 filed on Jul. 20, 2009.

### BACKGROUND

### Technical Field

The present invention relates to an opening/closing door, an apparatus housing the same and an image forming apparatus.

### SUMMARY

According to an aspect of the present invention, there is provided an opening/closing door for opening/closing a door opening formed in an apparatus housing including: a rotational shaft mounted at an edge portion of the door opening; a door base member that is fixed to the rotational shaft and rotates together with the rotational shaft; a door exterior member fixed to the exterior of the door base member; a plurality of positioning units that position the door exterior member to the door base member at locations distant from the rotational shaft; a plurality of fixing units that are provided to be more distant from the rotational shaft than the plurality of positioning units and fix the door exterior member to the door base member by attachments; and an opening/closing handle that is provided to the door exterior member so as to be closer to the fixing units than the positioning units in a direction substantially orthogonal to the rotational shaft.

### BRIEF DESCRIPTION OF THE DRAWINGS

An exemplary embodiment of the present invention will be described in detail based on the following figures, wherein:

FIG. 1A is a diagram showing an exemplary embodiment of an image forming apparatus to which the present invention is applied, and FIG. 1B is a diagram showing an apparatus housing of the image forming apparatus of FIG. 1A and an opening/closing door provided to the apparatus housing;

FIG. 2 is a perspective view showing the overall configuration of an image forming apparatus according to a first exemplary embodiment;

FIG. 3 is a diagram showing a state that an opening/closing door at the front side is opened according to the first exemplary embodiment;

FIG. 4 is a diagram showing an image forming element of an image forming apparatus according to the first exemplary embodiment;

FIG. 5 is a diagram showing a main part of an apparatus housing used in the first exemplary embodiment;

FIG. 6A is a diagram showing a gap treatment 1 of a specified color exterior cover of the first exemplary embodiment, FIG. 6B is a diagram showing a gap treatment 2 of the specified color exterior cover and FIG. 6C is a diagram showing a gap treatment 3 of an unspecified color exterior cover of the first exemplary embodiment;

FIG. 7A is a diagram showing a check treatment 1 of the specified color exterior cover of the first exemplary embodiment, FIG. 7B is a diagram showing a check treatment 2 of the specified color exterior cover and FIG. 7C is a diagram showing a check treatment 3 of the unspecified color exterior cover according to the first exemplary embodiment;

FIG. 8A is a diagram showing a front-side opening/closing door according to the first exemplary embodiment when the opening/closing door is viewed from the outside, and FIG. 8B is a diagram showing the opening/closing door when the opening/closing door is viewed from the inside;

FIG. 9 is an exploded diagram of the opening/closing door shown in FIG. 8A;

FIG. 10 is an exploded diagram showing the opening/closing door shown in FIG. 8B;

FIG. 11A is a diagram showing a front-side opening/closing door according to a second exemplary embodiment when the opening/closing door is viewed from the outside, and FIG. 11B is a diagram showing the opening/closing door when the opening/closing door is viewed from the inside;

FIG. 12 is an exploded diagram showing the opening/closing door shown in FIG. 11A; and

FIG. 13 is an exploded diagram showing the opening/closing door shown in FIG. 11B.

### DETAILED DESCRIPTION

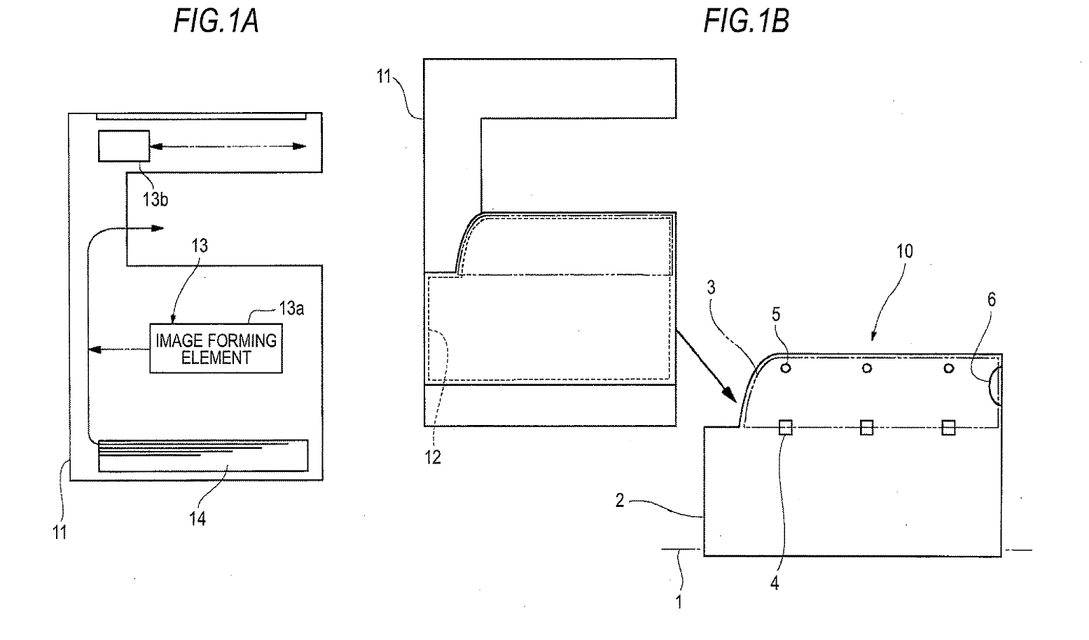

First, an exemplary embodiment of an image forming apparatus to which the present invention is applied will be briefly described with reference to FIG. 1A.

In FIG. 1A, the image forming apparatus has an apparatus housing 11 and an image forming element 13 contained in the apparatus housing 11. The image forming element 13 has an image forming element 13a for forming an image on a recording medium 14 and an image reading element 13b for reading a document image to be formed on a recording medium 14.

As shown in FIGS. 1A and 1B, this exemplary embodiment is provided with an opening/closing door 10 for opening/closing a door opening 12 formed in the apparatus housing 11.

Here, as shown in FIG. 1B, the opening/closing door 10 has a rotational shaft 1 mounted on the edge portion of the door opening 12, a door base member 2 which is fixed to the rotational shaft 1 and rotated together with the rotational shaft 1, a door exterior member 3 fixed to the exterior of the door base member 2, plural positioning units 4 for positioning the door exterior member 3 to the door base member 2 at a site which is distant (far away) from the rotational shaft 1, plural fixing units 5 which are provided to be more distant from the rotational shaft 1 than the plural positioning units 4 and fix the door exterior member 3 to the door base member 2 by checks, and an opening/closing knob 6 which is provided to the door exterior member 3 so as to be nearer to the fixing units 5 than the positioning units 4 with respect to the distance from the rotational shaft 1.

In the configuration as described above, the rotational shaft 1 may be configured to extend in any direction of the horizontal direction and the vertical direction. The door element may have the door base member 2 and the door exterior member 3, and both the members 2 and 3 may be colored so that they are not different in hue from each other or they are different in hue from each other from the viewpoint of design. Furthermore, the positioning units 4 may have a function of positioning the door base member 2 and the door exterior member 3, and it is necessary that there are plural positioning places. Still furthermore, the fixing units 5 may have a function of fixing the door base member 2 and the door exterior member 3, and it is necessary that there are plural fixing places. The opening/closing knob 6 is a knob for opening/closing the opening/closing door 10, and it may be provided at least one place.

In this exemplary embodiment, as a representative example of the opening/closing knob 6, the opening/closing knob 6 may be configured in a style that the locating position of the opening/closing knob 6 contains the locating position of each fixing unit 5 with respect to the distance from the locating position of the rotational shaft 1 (i.e., the displacement of the opening/closing knob 6 from the rotational shaft 1 is set to be equal or near to the displacement of the fixing units 5 from the rotational shaft 1), or in a style that the locating position of the opening/closing knob 6 is set to a position between the locating positions of the fixing unit 5 and the positioning unit 4 with respect to the distance from the locating position of the rotational shaft 1 (i.e., the displacement of the opening/closing knob 6 from the rotational shaft 1 is set to a displacement between the displacement of the fixing units 5 from the rotational shaft 1 and the displacement of the positioning unit 4 from the rotational shaft 1).

Furthermore, as a representative example of the positioning unit 4, any one member of the door base member 2 and the door exterior member 3 is provided with a positioning pawl extending along the door surface, and the other member is provided with a positioning hole in which the positioning pawl is inserted. In this exemplary embodiment, when the door exterior member 3 is positioned to the door base member 2, the door exterior member 3 may be moved along the surface direction of the door base member 2.

Still furthermore, in the style that the opening/closing knob 6 is positionally located between the fixing unit 5 and the positioning unit 4 with respect to the distance from the rotational shaft 1, a subsidiary regulating unit for regulating floating of the door exterior member 3 relatively to the door base member 2 may be provided between the fixing unit 5 and the positioning unit 4 with respect to the distance from the locating position of the rotational shaft 1 in the door base member 2 and the door exterior member 3.

In the style that the positioning unit 4 is provided as described above, an opening degree adjusting member is joined between the door base member 2 and the edge portion of the door opening 12, and the joint site of the opening degree adjusting member to the door base member 2 may be positionally more distant from the rotational shaft 1 than the positioning units 4. In this embodiment, when the opening/closing door 10 is opened, the door base member 2 is hauled by a hauling action of the opening degree adjusting member in such a direction that the positioning units 4 bite into the door base member 2.

Next, the present invention will be described in detail on the basis of exemplary embodiments shown in the figures.

### First Exemplary Embodiment

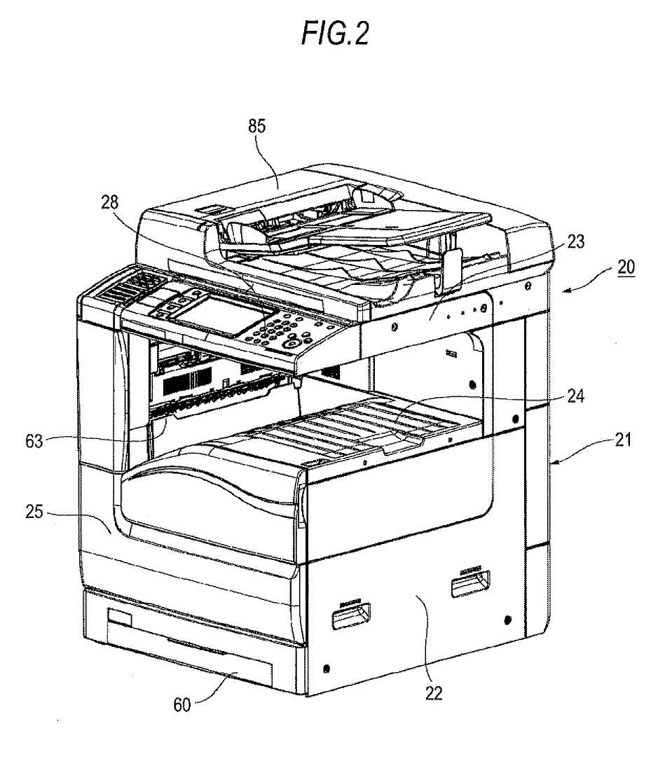

FIG. 2 is a perspective view showing the overall configuration of an image forming apparatus according to a first exemplary embodiment.

In FIG. 2, the image forming apparatus 20 has an apparatus housing 21 containing an image forming element, and the image forming element contains an imaging element for forming an image on a recording medium and an image reading element for reading a document image to be formed on a recording medium.

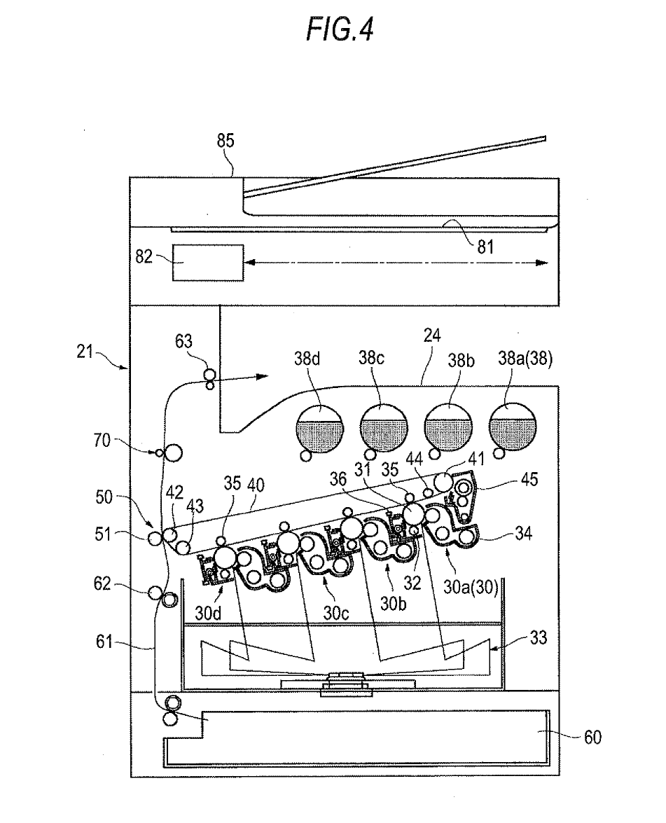

In this exemplary embodiment, as shown in FIG. 4, the imaging element has image forming units 30 (specifically, 30a to 30d) for forming plural color component images electrophotographically, an intermediate transfer medium 40 which is designed like a belt, for example and onto which images formed by the image forming units 30 are temporarily transferred before the images concerned are transferred onto a recording medium, and a batch transfer device 50 for collectively transferring onto a recording medium the respective component images which have been transferred on the intermediate transfer medium 40. A recording medium supplied from a recording medium supply device 60 disposed below the image forming units 30 is transported by a transporting roll 62 in a transporting path 61 extending substantially vertically, and images on the intermediate transfer medium 40 are collectively transferred onto the recording medium at a transfer site of the batch transfer device 50. Furthermore, the images on the recording medium are fixed by a fixing device 70 provided at the downstream side of the transporting path 61, and then the recording medium concerned is discharged into a recording medium stock unit 24 described later by a discharge roll 63 disposed just before the recording medium stock unit 24.

Here, each image forming unit 30 (30a to 30d) has, for example, a drum-shaped photoconductor 31, a charger 32 for charging the photoconductor 31, an exposure unit 33 such as a laser scanning device or the like for writing an electrostatic latent image on the charged photoconductor 31 with light, a developing unit 34 for developing the electrostatic latent image formed on the photoconductor 31 with a predetermined color component toner, a transfer unit 35 for transferring the developed image on the photoconductor 31 onto the intermediate transfer medium 40, and a cleaner 36 for cleaning residual toner on the photoconductor 31.

Reference numeral 38 (38a to 38d) represents a toner replenishing unit for replenishing each color component toner to the developing unit 34 of each image forming unit 30. In this exemplary embodiment, the exposure unit 33 may be provided every image forming unit 30 (30a to 30d), however, it may be commonly used by all the image forming units 30.

Furthermore, in this exemplary embodiment, the intermediate transfer medium 40 is laid over plural tension rolls 41 to 44, and circulatively rotated with the tension roll 41 as a driving roll. Reference numeral 45 is an intermediate cleaner which is provided at the downstream side of the batch transfer device 50 in the transporting direction of the intermediate transfer medium 40 and cleans residual toner on the intermediate transfer medium 40.

Furthermore, the batch transfer device 50 has a batch transfer roll 51, and the batch transfer roll 51 pinches the intermediate transfer medium 40 in cooperation with the tension roll 42 of the intermediate transfer medium 40 which serves as a counter roll. Transfer electric field is formed between the batch transfer roll 51 and the tension roll 42 serving as the counter roll due to application of a transfer voltage therebetween.

The image reading element has a document table 81 on which a document to be read is placed. The document on the document table 81 is read by an image reading unit (scanner) 82, and an image signal of each color component is supplied to the exposure unit 33 through an image processor (not shown). Reference numeral 85 represents an automatic document feeder for automatically feeding a document onto the document table 81.

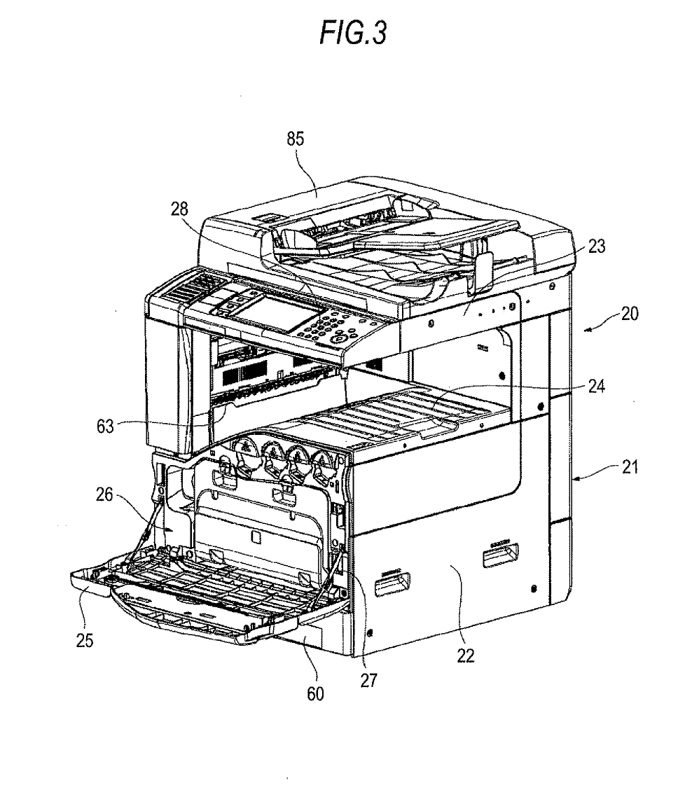

In this exemplary embodiment, as shown in FIGS. 2 and 3, the apparatus housing 21 has a lower apparatus housing 22 containing the imaging element for forming an image on a recording medium (not shown), an upper apparatus housing 23 containing the image reading element for reading a document image to be formed on a recording medium (not shown), and a recording medium stock unit 24 which is provided between the lower apparatus housing 22 and the upper apparatus housing 23 and stocks a recording medium on which an image is formed by the imaging element in the lower apparatus housing 22. An opening/closing door 25 is provided at the front side of the lower apparatus housing 22.

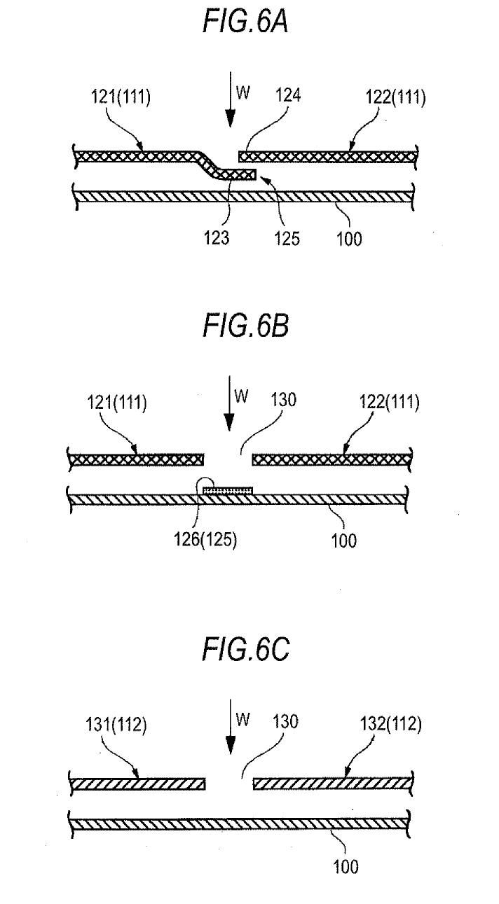

Furthermore, the apparatus housing 21 has a housing frame 100 (see FIG. 6) formed of a metal raw material such as SUS, aluminum or the like which serves as a framework of the apparatus housing 21, and an exterior cover 110 fixed to the exterior of the housing frame 100.

In this embodiment, as shown in FIGS. 2, 3 and 5, the exterior cover 110 has a specified-color exterior cover 111 having a specified-color (for example, blue) which is different in hue from the housing frame 100, and an unspecified-color exterior cover 112 which is provided separately from the specified-color exterior cover 111 and colored with a hue which is not different from the housing frame 100.

In this embodiment, particularly, the density of the specified-color of the specified-color exterior cover 111 is different from the density of the housing frame 100 by three or more in the Munsell density, and the specified-color exterior cover 111 is more conspicuous in color as compared with the unspecified-color exterior cover 112.

Here, the specified-color exterior cover 111 represents an exterior cover having a specified-color different in hue from the housing frame 100. Here, “difference in hue” is properly determined on the basis of whether a person who looks at the housing frame 100 through a gap of the exterior cover 110 feels odd about the difference in hue between the exterior cover 110 and the housing frame 100.

Furthermore, in this exemplary embodiment, in a case where each of the exterior cover 110 and the housing frame 100 is expressed by three attributes of color (hue, brightness, color saturation) of the Munsell color system, it may be considered that the exterior cover 110 is regarded as an exterior cover 111 of a specified-color when the difference in each of hue, brightness and color saturation between the exterior cover 110 and the housing frame 100 is equal to three or more, and also regarded as an exterior cover 112 of an unspecified-color when the difference is equal to 2 or less. Furthermore, in a case where the distance on the space of a uniform color space is expressed by using the L*a*b color system, the exterior cover is regarded as an exterior cover 111 of a specified-color when the value of ΔE=[(ΔL)*2+(Δ*a)*2+(Δ*a)*2]^{1/2} is equal to about 10 or more.

According to this exemplary embodiment, the specified-color exterior cover 111 is disposed so as to surround the recording medium stock member 24 and the peripheral site thereof, the unspecified-color exterior cover 112 is disposed around the specified-color exterior cover 111, and these exterior covers (the specified-color exterior cover 111 and the unspecified-color exterior cover 112) are fixed to the housing frame 100 by using checks. However, the fixing structure of the specified-color exterior cover 111 is slightly different from the fixing structure of the unspecified-color exterior cover 112.

The fixing structures of the specified-color exterior cover 111 and the unspecified-color exterior cover 112 will be described hereunder.

### (1) Gap Treatment 1

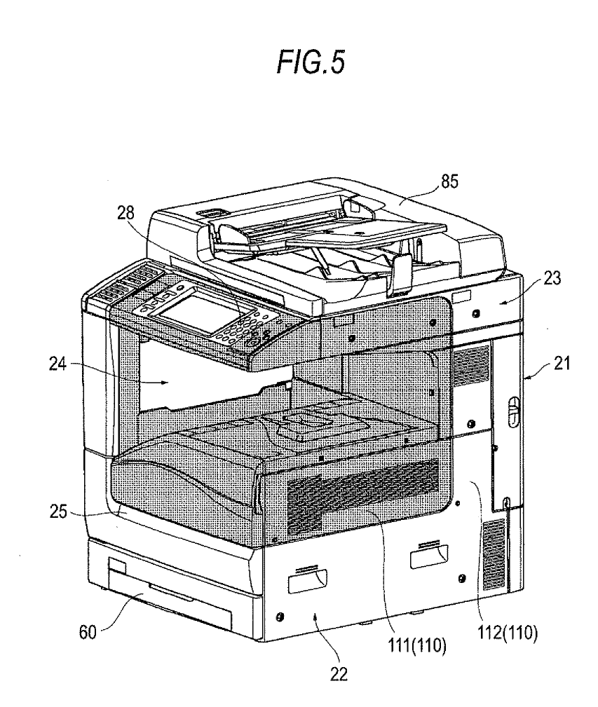

In some cases, plural cover members 121 and 122 are adjacently disposed as the specified-color exterior cover 111 on one certain surface of the apparatus housing 21 as shown in FIGS. 5 and 6A. At this time, in this exemplary embodiment, overhead flanges 123 and 124 are respectively provided to the cover members 121 and 122 of the specified-color exterior cover 111 so that each of the overhead flanges extends over the end of the other overhead flange at the adjacent site between both the cover members 121 and 122. In this exemplary embodiment, one overhead flange 123 extends while bent to the housing frame 100 side and the other overhead flange 124 extends just linearly so that both the overhead flanges 123 and 124 are overlapped with each other. Accordingly, the overhead flanges 123 and 124 act as a blinder portion 125 for interrupting the visual line from the external as indicated by an arrow W.

As a result, even when the adjacent site between the cover members 121 and 122 of the specified-color exterior cover 111 is viewed from the external, the surface of the housing frame 100 is blindfolded by the blinder portion 125 including the overhead flanges 123 and 124, so that the surface of the housing frame 100 is hardly exposed through the adjacent site between the cover members 121 and 122.

### (2) Gap Treatment 2

Even when a gap 130 is formed at the adjacent site between the plural cover members 121 and 122 of the specified-color exterior cover 111, blind paint 126 is coated on the surface of the housing frame 100 at the position corresponding to the gap 130 between the cover members 121 and 122, whereby the coating based on the blind paint 126 acts substantially as the blinder portion 125 as shown in FIG. 6B, for example.

Here, coating based on paint whose color is not different in hue from the specified-color exterior cover 111 (for example, blue paint or black paint) may be formed as the blind paint 126.

### (3) Gap Treatment 3

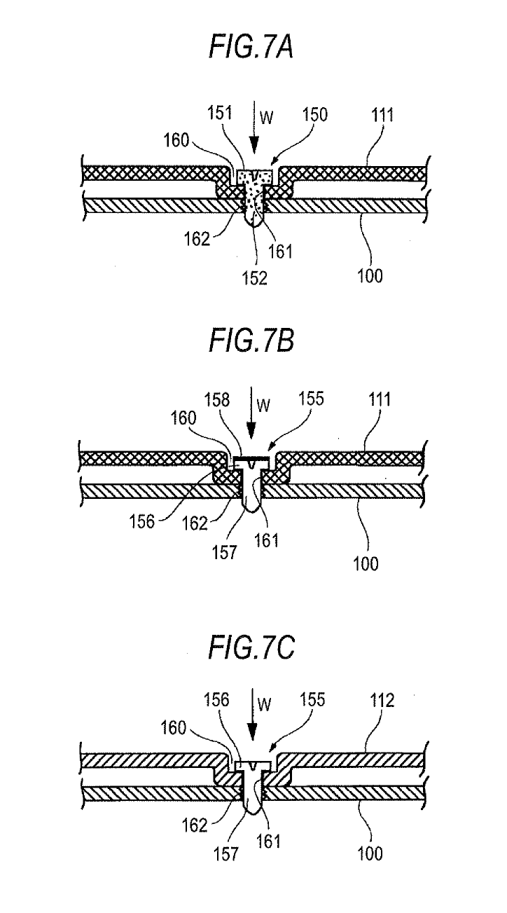

In some cases, plural cover members 131 and 132 are adjacently disposed as the unspecified-color exterior cover 112 on one certain surface of the apparatus housing 21 as shown in FIGS. 5 and 6C. At this time, even in a case where the gap 130 is formed between the plural cover members 131 and 132 as shown in FIG. 7C, if the surface of the housing 100 is exposed through the gap 130 between the cover members 131 and 132, there is no concern that the exposed portion causes conspicuous degradation in appearance quality because the color of the unspecified-color exterior cover 112 is not different in hue from the color of the housing frame 100.

Next, a fixing structure using a check for each of the specified-color exterior cover 111 and the unspecified-color exterior cover 112 will be described.

### (1) Check Treatment 1

As shown in FIGS. 5 and 7A, the specified-color exterior cover 111 is fixed to the housing frame 100 by using checks 150. In this exemplary embodiment, the specified-color exterior cover 111 may have an insertion hole 161 formed therein. The insertion hole 161 forms a fixing recess portion 160 in which the head portion 151 of the check 150 is mounted, and a screw portion 152 of the check 150 can be inserted into the bottom of the fixing recess portion 160. A color (blue, black) whose hue is not different from that of the specified-color exterior cover 111 may be selected as the color of the check 150. A female screw portion 162 in which the screw portion 152 of the check 150 is engagedly fitted is formed in the housing frame 100 as a fixing target in advance.

According to the fixing structure as described above, with respect to the check 150 of the specified-color exterior cover 111, the head portion 151 thereof is mounted in the fixing recess portion 160, and the screw portion 152 thereof is engagedly fitted in the female screw portion 162 of the housing frame 100 through the insertion hole 161 of the fixing recess portion 160. At this time, the head portion 151 of the check 150 is viewable from the external of the specified-color exterior cover 111. However, the check 150 is colored with a hue which is not different from that of the specified-color exterior cover 111, so that existence of the checks 150 in the area of the specified-color exterior cover 111 is not so conspicuous.

### (2) Check Treatment 2

As shown in FIGS. 5 and 7B, the specified-color exterior cover 111 is fixed to the housing frame 100 through checks 155. In this exemplary embodiment, the specified-color exterior cover 111 has an insertion hole 161 formed therein. The insertion hole 161 forms a fixing recess portion 160 in which the head portion 156 of the check 155 is mounted, the screw portion 157 of the check 155 can be inserted into the bottom of the fixing recess portion 160, and the screw portion 157 is engagedly fitted in a female screw portion 162 of the housing frame 100. Unlike FIG. 7A, the check 155 itself is a silver screw, for example, and a blind paint 158 of color (blue or black) which is not different in hue from the color of the specified-color exterior cover 111 is coated on the head portion 156 of the check 155.

According to this exemplary embodiment, even when the specified-color exterior cover 111 is fixed to the housing frame 100 through the check 155, the head portion 156 of the check 155 is blindfolded by the blind paint 158. Therefore, the head portion 156 of the check 155 is not directly exposed to the outside, and thus there hardly occurs such a situation that the check 155 is conspicuous in the area of the specified-color exterior cover 111.

### (3) Check Treatment 3

As shown in FIGS. 5 and 7C, the unspecified-color exterior cover 112 is fixed to the housing frame 100 through the checks 155.

At this time, the unspecified-color exterior cover 112 has the insertion hole 161 formed therein. The insertion hole 161 forms the fixing recess portion 160 in which the head portion 156 of the check 155 is mounted, the screw portion 157 of the check 155 can be inserted into the bottom of the fixing recess portion 160 and the screw portion 157 is engagedly fitted in the female screw portion 162 of the housing frame 100. For example, the head portion 156 of the check 155 such a silver screw or the like is mounted in the fixing recess portion 160 in the area of the unspecified-color exterior cover 112, however, the head portion is exposed to the surface. However, the check 155 is colored with a hue which is not different from that of the color of the unspecified-color exterior cover 112, and thus there is little concern that existence of the check 155 is conspicuous in color in the area of the unspecified-color exterior cover 112.

Next, the structure of the opening/closing door 25 according to this exemplary embodiment will be described.

In this embodiment, the opening/closing door 25 is configured so as to straddle the specified color exterior cover 111 and the unspecified color exterior cover 112.

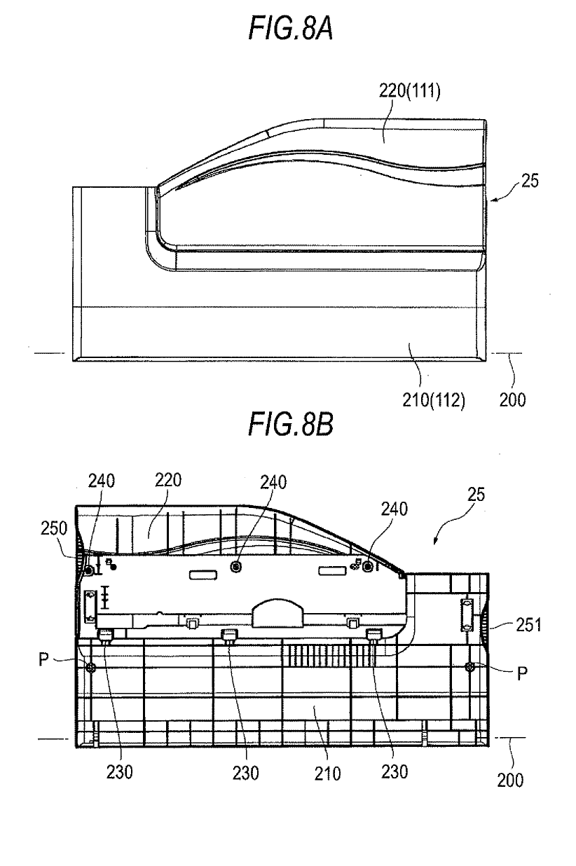

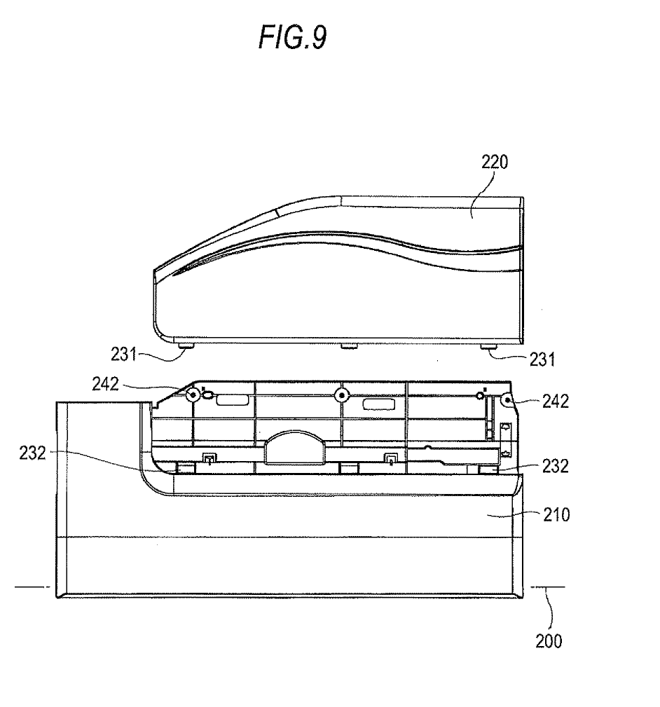

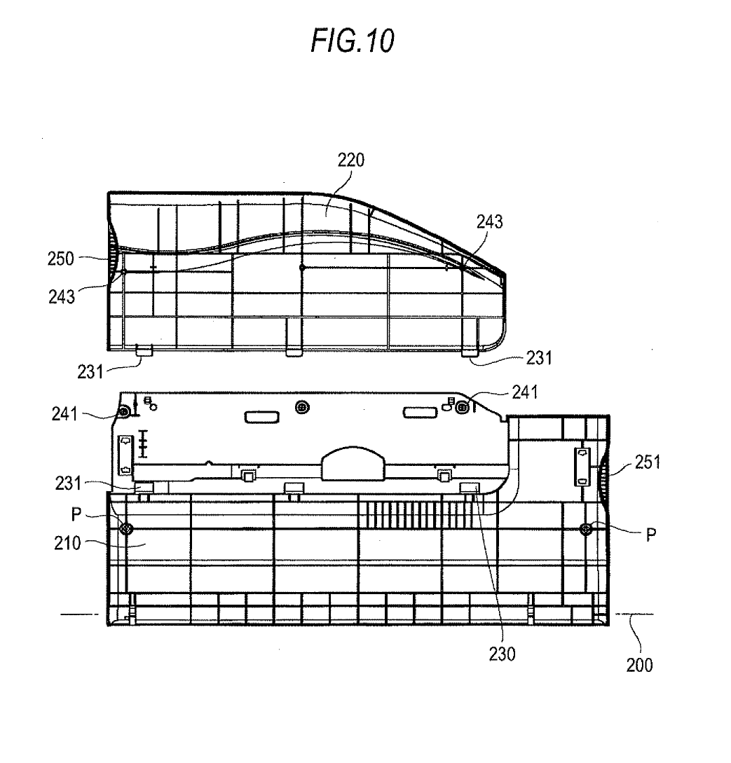

Here, as shown in FIG. 3 and FIGS. 8A to 10, the opening/closing door 25 has a rotational shaft 200 extending in a horizontal direction at the lower edge portion of the door opening port 26 (see FIG. 3) of the apparatus housing 21, a substantially rectangular door base member 210 which is fixed to the rotational shaft 200 and rotates together with the rotational shaft 200, and a door exterior member 220 which is fixed to an outside portion of the door base member 210 excluding an L-shaped portion and disposed so as to project more upwardly as compared with the door base member 210. In this exemplary embodiment, the door base member 210 constitutes a part of the unspecified color exterior cover 112, and the door exterior member 220 constitutes a part of the specified color exterior cover 111.

In this exemplary embodiment, there are provided plural positioning units 230 for positioning the door exterior member 220 to the door base member 210 are provided, and plural fixing units 240 which are more distant from the rotational shaft 200 than the plural positioning units 230 and fix the door exterior member 220 to the door base member 210 by checks 241. Furthermore, the door exterior member 220 is provided with an opening/closing knob 250 so that the opening/closing knob 250 is nearer to the fixing units 240 than the positioning units 230 with respect to the distance from the locating position of the rotational shaft 200.

Particularly, in this exemplary embodiment, with respect to the positioning units 230, plural (three in this exemplary embodiment) positioning pawls 231 extending downwardly along the direction of the door surface are provided to the lower edge portion of the door exterior member 220, and rectangular positioning holes 232 in which the respective positioning pawls 231 are inserted are provided to the lower portion of the fixing site of the door base member 210 to which the door exterior member 220 is fixed.

Furthermore, with respect to the fixing units 240, plural (three in this exemplary embodiment) fixing holes 242 are formed at the upper portion of the door base member 210, and female screw portions 243 are formed at the inside of the door exterior member 220 in connection with the respective fixing holes 242. Checks 241 are inserted from the inside of the door base member 210 into the fixing holes 242, and also screwed into the female screw portions 243 of the door exterior member 220, whereby the door exterior member 220 is fixed to the door base member 210.

The opening/closing knob 250 is provided to the edge portion in the vertical direction of the door exterior member 220, and it extends in the up-and-down direction so that the position thereof contains the respective positions of the fixing units 240 with respect to the distance from the rotational shaft 200. Reference numeral 251 represents a subsidiary opening/closing knob which is provided to the edge portion in the vertical direction of the door base member 210 so as to be located at the opposite side to the opening/closing knob 250 and used subsidiarily when the opening/closing door 25 is opened/closed.

Furthermore, in this exemplary embodiment, as shown in FIG. 3, opening degree adjusting members 27 are joined between the door base member 210 of the opening/closing door 25 and the edge portion of the door opening 26, and the joint site P between each opening degree adjusting member 27 and the door base member 210 is disposed to be positionally nearer to the rotational shaft 200 than the positioning units 230. The opening degree adjusting member 27 may be a rod which can be crooked (bent), or may be a string-shaped strap.

Next, a method of configuring the opening/closing door according to the exemplary embodiment will be described.

In order to fix the door exterior member 220 to the door base member 210, the positioning pawls 231 of the door exterior member 220 are first inserted into the positioning holes 232 of the door base member 210 to position the door exterior member 220 to the door base member 210. Thereafter, the checks 241 are inserted into the fixing holes 242 of the door base member 210, and screwed into the door exterior member 220 to fix the door exterior member 220 to the door base member 210.

When the opening/closing door 25 is opened/closed under the above state while the opening/closing knob 250 is grasped by a user, the door exterior member 220 does not float from the door base member 210, and thus the door base member 210 and the door exterior member 220 are integrally opened/closed because the opening/closing knob 250 is disposed so that the position thereof contains the positions of the fixing units 240 with respect to the distance from the rotational shaft 200.

Furthermore, in this exemplary embodiment, the positioning unit 230 positions the door base member 210 and the door exterior member 220 in the direction intersecting to the fixing direction of the fixing units 240. Therefore, even when the opening/closing door 25 is opened/closed, there is little concern that the positioning units 230 are detached.

### Second Exemplary Embodiment

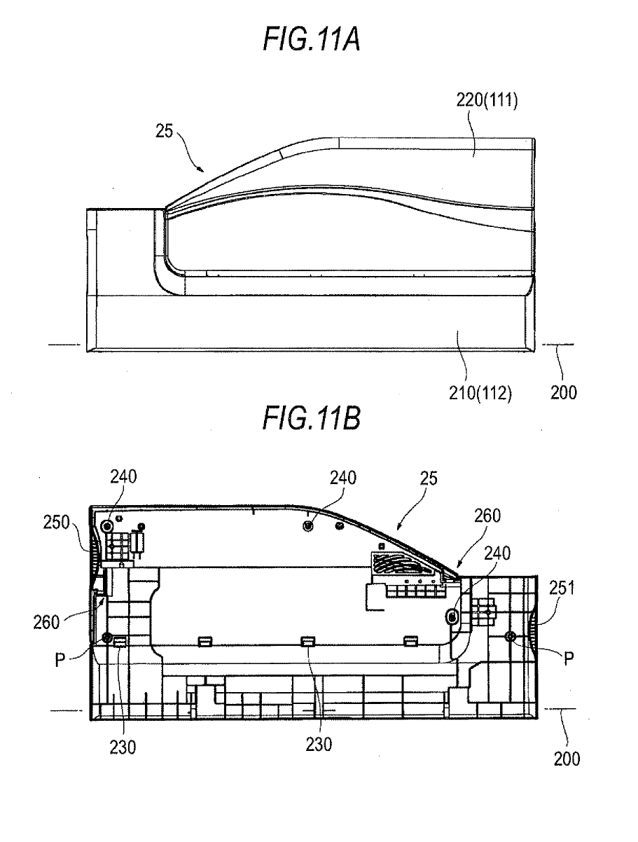

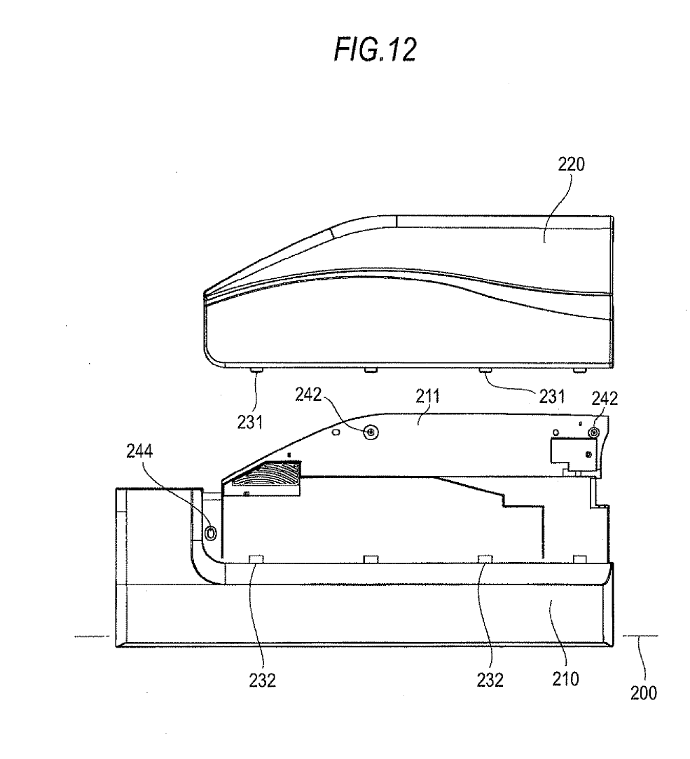

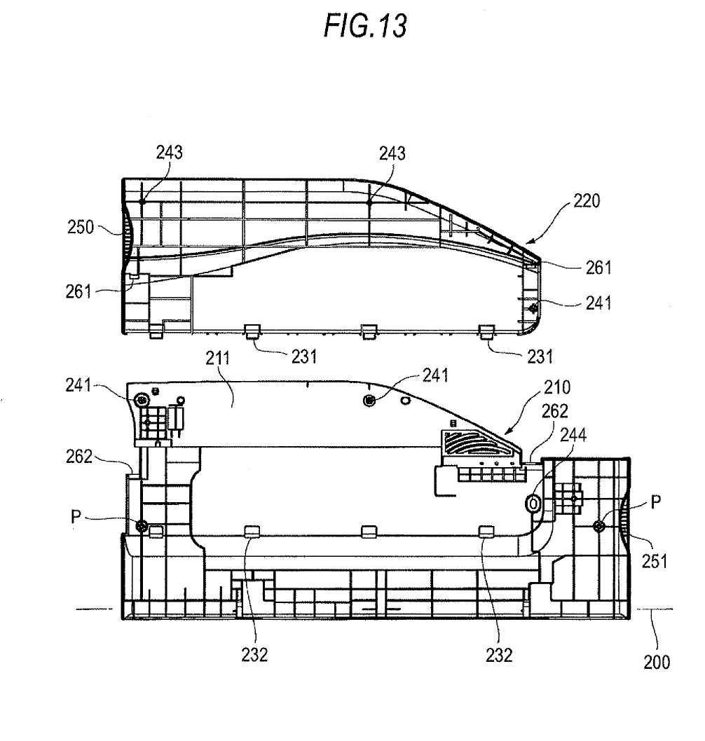

FIGS. 11 to 13 show a main part of an opening/closing door used in a second exemplary embodiment.

In FIGS. 11 to 13, the opening/closing door 25 has a rotational shaft 200, a door base member 210 and a door exterior member 220 as in the case of the first exemplary embodiment.

In this exemplary embodiment, the door base member 210 has a projecting portion 211 which projects upwardly from a substantially rectangular portion and inclines to one side, and the door exterior member 220 is fixed to a portion of the door base member 210 which excludes a substantially L-shaped portion and contains the projecting portion 211.

In this exemplary embodiment, the positioning units 230 has plural (four in this exemplary embodiment) positioning pawls 231 extending downwardly along the direction of the door surface at the lower edge portion of the door exterior member 220, and rectangular positioning holes 232 in which the respective positioning pawls 231 are inserted are formed at the lower portion of a fixing site of the door base member 210 at which the door exterior member 220 is fixed.

The fixing units 240 have plural (two in this exemplary embodiment) fixing holes 242 formed at the upper portion of the projecting portion 211 of the door base member 210, a fixing hole 244 is formed at a part of the rectangular portion of the door base member 210, and female screw portions 243 are formed in correspondence to the respective fixing holes 242 and 244. In this exemplary embodiment, the fixing hole 244 is configured as an elongated hole extending in the up-and-down direction, whereby the locating position of the door exterior member 220 on the door base member 210 can be finely adjusted.

Furthermore, the opening/closing knob 250 is provided to the edge portion in the vertical direction of the door exterior member 220 so that the locating position thereof is set to the intermediate position between the position of the fixing hole 242 of the fixing unit 240 and the positioning unit 230 with respect to the distance from the rotational shaft 200. Reference numeral 251 represents a subsidiary opening/closing knob as in the case of the first exemplary embodiment.

In this exemplary embodiment, subsidiary regulating units 260 are provided at the front and rear portions of the projecting portion 211 of the door base member 210 and at the substantially center portions of the front and rear portions in the vertical direction of the door exterior member 220. The subsidiary regulating member 260 has regulating pawls 261 which are provided to the lower side of the door exterior member 220 so as to extend downwardly in a hook-shape, and also regulating holes 262 which are provided to the door base member 210 side so that the regulating pawls 261 are hooked to the regulating holes 262 so as to embrace the regulating holes 262. The engagement between the regulating pawls 261 and the regulating holes 262 prevents the floating of the door exterior member 220 from the door base member 210.

Furthermore, in this exemplary embodiment, the opening degree adjusting members 27 (see FIG. 3) are joined between the door base member 210 of the opening/closing door 25 and the edge portion of the door opening 26 as in the first exemplary embodiment. However, in this exemplary embodiment, the locating position of the joint site P between the opening degree adjusting member 27 and the door base member 210 is more distant from the rotational shaft 200 than the positioning units 230 unlike the first exemplary embodiment.

Next, the method of configuring the opening/closing door according to this exemplary embodiment will be described.

In order to fix the door exterior member 220 to the door base member 210, the positioning pawls 231 of the door exterior member 220 are inserted into the positioning holes 232 of the door base member 210, and the regulating pawls 261 of the door exterior member 220 are hooked to the regulating holes 262 of the door base member 210, whereby the door exterior member 220 is positioned to the door base member 210. Thereafter, the checks 241 are inserted into the fixing holes 242 and 244 of the door base member 210, and screwed into the door exterior member 220, whereby the door exterior member 220 is fixed to the door base member 210.

When a user opens/closes the opening/closing door 25 under the above state while grasping the opening/closing knob 250, there is a concern that the door exterior member 220 more floats from the door base member 210 as the locating position of the opening/closing knob 250 is more distant from the locating position of the fixing hole 242 in the style that no subsidiary regulating unit 260 is provided because the locating position of the opening/closing knob 250 is set to the intermediate position between the fixing hole 242 of the fixing unit 240 and the positioning unit 230 with respect to the distance from the rotational shaft 200.

However, in this exemplary embodiment, the floating of the door exterior member 220 is regulated at the intermediate portion in the up-and-down direction of the door base member 210 by the subsidiary regulating unit 260, and thus the door exterior member 220 does not float from the door base member 210. Therefore, the door base member 210 and the door exterior member 220 are integrally opened/closed.

Furthermore, according to this exemplary embodiment, unlike the first exemplary embodiment, when tension acts on the opening degree adjusting member 27 at the opening time of the opening/closing door 25, the positioning pawl 231 of the positioning unit 230 is pushed and engaged into the positioning hole 232 by the action of the tension because the locating position of the joint site P between the opening degree adjusting member 27 and the door base member 210 is more distant from the rotational shaft 200 than the positioning units 240. Therefore, the positioning pawl 231 of the positioning unit 230 can be more surely prevented from dropping off the positioning hole 232 as compared with the first exemplary embodiment.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical application, thereby enabling others skilled in the art to understand the invention for various embodiments and with the various modifications as are suited to the particular use contemplated. It is intended that the scope of the invention be defined by the following claims and their equivalents.

What is claimed is:

1. An opening/closing door for opening/closing a door opening formed in an apparatus housing comprising:
a rotational shaft mounted at an edge portion of the door opening;
a door base member that is fixed to the rotational shaft and rotates together with the rotational shaft;
a door exterior member fixed to the exterior of the door base member;
a plurality of positioning units that position the door exterior member to the door base member at locations distant from the rotational shaft;
a plurality of fixing units that are provided to be more distant from the rotational shaft than the plurality of positioning units and fix the door exterior member to the door base member by attachments; and
an opening/closing handle that is provided to the door exterior member so as to be closer to the fixing units than the positioning units in a direction substantially orthogonal to the rotational shaft.

2. The opening/closing door according to claim 1, wherein the locating position of the opening/closing handle is provided to be more distant from the rotational shaft than the plurality of fixing units in the direction substantially orthogonal to the rotational shaft.

3. The opening/closing door according to claim wherein the opening/closing handle is provided between the plurality of fixing units and the plurality of positioning units in the direction substantially orthogonal to the rotational shaft.

4. The opening/closing door according to claim 1, wherein each of the positioning units has a positioning pawl that is provided to any one member of the door base member and the door exterior member so as to extend along a door surface in the direction substantially orthogonal to the rotational shaft, and a positioning hole that is provided to the other member so that the positioning pawl is inserted in the positioning hole.

5. The opening/closing door according to claim 3, further comprising a subsidiary regulating unit that is provided between the plurality of fixing units and the plurality of positioning units in the direction substantially orthogonal to the rotational shaft and regulates floating of the door exterior member from the door base member.

6. The opening/closing door according to claim 4, further comprising an opening degree adjusting member that connects the door base member and an edge portion of the door opening, and a location of the door base member where the opening degree adjusting member is connected is more distant from the rotational shaft than the positioning units.

7. An apparatus housing comprising:
an door opening; and
an opening/closing door that opens/closes the door opening, and includes a rotational shaft mounted at an edge portion of the door opening, a door base member that is fixed to the rotational shaft and rotates together with the rotational shaft, a door exterior member fixed to the door base member, a plurality of positioning units that position the door exterior member to the door base member at locations distant from the rotational shaft, a plurality of fixing units that are provided to be more distant from the rotational shaft than the plurality of positioning units and fix the door exterior member to the door base member by attachments, and an opening/closing handle that is provided to the door exterior member so as to be closer to the fixing units than the positioning units in a direction substantially orthogonal to the rotational shaft.

8. The apparatus housing according to claim 7, wherein the locating position of the opening/closing handle is provided to be more distant from the rotational shaft than the plurality of fixing units in the direction substantially orthogonal to the rotational shaft.

9. The apparatus housing according to claim 7, wherein the opening/closing handle is provided between the plurality of fixing units and the plurality of positioning units in the direction substantially orthogonal to the rotational shaft.

10. The apparatus housing according to claim 7, wherein each of the positioning units has a positioning pawl that is provided to any one member of the door base member and the door exterior member so as to extend along a door surface in the direction substantially orthogonal to the rotational shaft, and a positioning hole that is provided to the other member so that the positioning pawl is inserted in the positioning hole.

11. The apparatus housing according to claim 9, wherein the opening/closing door further includes a subsidiary regulating unit that is provided between the plurality of fixing units and the plurality of positioning units in the direction substantially orthogonal to the rotational shaft and regulates floating of the door exterior member from the door base member.

12. The apparatus housing according to claim 10, wherein the opening/closing door further includes an opening degree adjusting member that connects the door base member and an edge portion of the door opening, and a location of the door base member where the opening degree adjusting member is connected is more distant from the rotational shaft than the positioning units.

13. An image forming apparatus comprising:
an apparatus housing including an door opening, and an opening/closing door that opens/closes the door opening and includes a rotational shaft mounted at an edge portion of the door opening, a door base member that is fixed to the rotational shaft and rotates together with the rotational shaft, a door exterior member fixed to the door base member, a plurality of positioning units that position the door exterior member to the door base member at locations distant from the rotational shaft, a plurality of fixing units that are provided to be more distant from the rotational shaft than the plurality of positioning units and fix the door exterior member to the door base member by attachments, and an opening/closing handle that is provided to the door exterior member so as to be closer to the fixing units than the positioning units in a direction substantially orthogonal to the rotational shaft; and
an image forming element contained in the apparatus housing.

14. The image forming apparatus according to claim 13, wherein the opening/closing door has the door base member larger than the door exterior member, and the door exterior member is colored with a specified color that is different in hue from the color of the door base member.

15. The image forming apparatus according to claim 13, wherein the locating position of the opening/closing handle is provided to be more distant from the rotational shaft than the plurality of fixing units in the direction substantially orthogonal to the rotational shaft.

16. The image forming apparatus according to claim 13, wherein the opening/closing handle is provided between the plurality of fixing units and the plurality of positioning units in the direction substantially orthogonal to the rotational shaft.

17. The image forming apparatus according to claim 13, wherein each of the positioning units has a positioning pawl that is provided to any one member of the door base member and the door exterior member so as to extend along a door surface in the direction substantially orthogonal to the rotational shaft, and a positioning hole that is provided to the other member so that the positioning pawl is inserted in the positioning hole.

18. The image forming apparatus according to claim 16, wherein the opening/closing door further includes a subsidiary regulating unit that is provided between the plurality of fixing units and the plurality of positioning units in the direction substantially orthogonal to the rotational shaft and regulates floating of the door exterior member from the door base member.

19. The image forming apparatus according to claim 17, wherein the opening/closing door further includes an opening degree adjusting member that connects the door base member and an edge portion of the door opening, and a location of the door base member where the opening degree adjusting member is connected is more distant from the rotational shaft than the positioning units.

20. The image forming apparatus according to claim 15, wherein the opening/closing door has the door base member larger than the door exterior member, and the door exterior member is colored with a specified color that is different in hue from the color of the door base member.
